(19) United States
(12) Patent Application Publication
(10) Pub. No.: US 2021/0327416 A1
(43) Pub. Date: Oct. 21, 2021

(54) VOICE DATA CAPTURE

(71) Applicant: HEWLETT-PACKARD DEVELOPMENT COMPANY, L.P., Spring, TX (US)

(72) Inventors: Alexander Wayne Clark, Houston, TX (US); Kent E Biggs, Houston, TX (US)

(21) Appl. No.: 16/481,496

(22) PCT Filed: Jul. 28, 2017
(86) PCT No.: PCT/US2017/044399

§ 371 Date: Jul. 29, 2019

(51) Int. Cl. G10L 15/22; G10L 15/08; H04L 12/18

(52) U.S. Cl. CPC G10L 15/22; G10L 15/08; G10L 2015/088; G10L 2015/225; G10L 2015/228; H04L 12/1818

(57) ABSTRACT

Examples disclosed herein provide a computing device. One example computing device includes a processor to capture voice data from a teleconference that the computing device is logged into, analyze the captured voice data to determine words in the voice data, and, based on the words, output a word suggestion to a display.

### BACKGROUND

Collaborative communication between different parties is an important part of today's world. People meet with each other on a daily basis by necessity and by choice, formally and informally, in person and remotely. There are different kinds of meetings that can have very different characteristics. In any meeting, an effective communication between the different parties is one of the main keys for success.

### BRIEF DESCRIPTION OF THE DRAWINGS

FIG. 1 illustrates a computing device for outputting suggestions in real-time, based on captured voice data, according to an example;

FIG. 2 illustrates a method at a computing device for outputting suggestions in real-time, based on captured voice data, according to an example;

FIG. 3 illustrates a computing device for alerting a participant in real-time, based on captured voice data, according to an example;

FIG. 4 illustrates a method at a computing device for alerting a participant in real-time, based on captured voice data, according to an example; and

FIG. 5 is a flow diagram in accordance with an example of the present disclosure.

### DETAILED DESCRIPTION

Communication technologies, both wireless and wired, have seen dramatic improvements over the past years. A large number of the people who participate in meetings today carry at least one computing device, such as a notebook computer or smartphone, where the device is equipped with a diverse set of communication or radio interfaces. Through these interfaces, the computing device can establish communications with the devices of other users, a central processing system, reach the Internet, or access various data services through wireless or wired networks. With regards to teleconferences, where some participants may be gathered in a conference room for the teleconference, and other participants may be logged into the teleconference from remote locations, each participant, whether local or remote, may be logged into the teleconference from their respective devices.

Examples disclosed herein provide the ability for a participant's computing device to continually analyze conversations by participants, for example, during a teleconference, for contextual information. The contextual information may then be used by the participant's computing device to proactively provide relevant information to the participant, for example, on a visual display of the computing device, where the relevant information is pertinent to communications currently being spoken by the participant or others. By constantly analyzing the conversation for contextual information, the computing device is able to provide real-time feedback to the participant, in order to more effectively communicate. Although teleconferencing will be described as the medium of communication that the participant may be utilizing, other mediums of communication may apply as well. For example, while the participant is speaking before an audience, a teleprompter may capture contextual information from what the participant has spoken thus far, and provide relevant information to the participant while speaking.

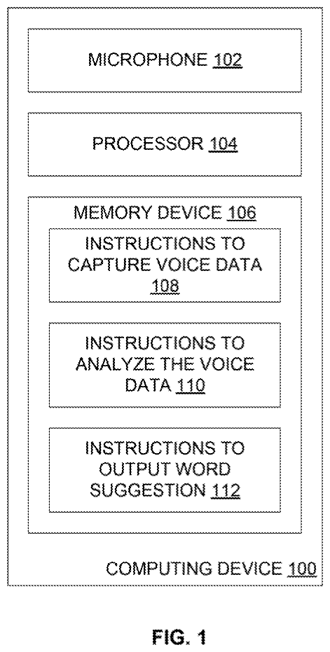

With reference to the figures. FIG. 1 illustrates a computing device 100 for outputting suggestions in real-time, based on captured voice data, according to an example. The computing device 100 may correspond to a portable computing device, such as a smartphone or a notebook computer, with a microphone 102 associated with the computing device 100. As an example, the microphone 102 may be internal to the computing device 100 or external to the computing device 100, such as a Bluetooth headset. As described above, a participant may log into a teleconference using the computing device 100, and participate in the teleconference by speaking into microphone 102. As will be further described, the computing device 100 may continually analyze conversations between participants during the teleconference to provide real-time contextual feedback to the participant, thereby boosting the participant's confidence to participate in the teleconference and providing for a more efficient conversation. Examples of suggestions include, but are not limited to, words suggestions to help the participant to complete a sentence, and alternate word selections when the participant is using a particular word too often.

The computing device 100 depicts a processor 104 and a memory device 106 and, as an example of the computing device 100 performing its operations, the memory device 106 may include instructions 108-112 that are executable by the processor 104. Thus, memory device 106 can be said to store program instructions that, when executed by processor 104, implement the components of the computing device 100. The executable program instructions stored in the memory device 106 include, as an example, instructions to capture voice data (108), instructions to analyze the voice data (110), and instructions to output a word suggestion (112).

Instructions to capture voice data (108) represent program instructions that when executed by the processor 104 cause the computing device 100 to capture voice data from a teleconference that the computing device 100 is logged into. The captured voice data may correspond to participants speaking into the microphone 102 of the computing device 100 and other participants logged into the teleconference from remote locations, for example, from their own computing devices. As an example, voice recognition techniques may be used to differentiate one participant from another.

Instructions to analyze the voice data (110) represent program instructions that when executed by the processor 104 cause the computing device 100 to analyze the captured voice data to determine words in the voice data. As an example, speech recognition (SR) systems may be used to determine the words in the voice data. Although speaker independent systems may be used for determining the words in the voice data, where the same algorithm is used for determining words spoken by each participant, speaker dependent systems may be used for improving accuracy of determining the words in the voice data spoken by a particular participant. Training may be provided in advance, where participants may read text or isolated vocabularies for a speaker dependent SR system. As a result, when the voice of a participant is recognized on the teleconference, the speaker dependent SR system may fine-tune the recognition of that participant's speech, resulting in increased accuracy of determining words spoken.

Instructions to output a word suggestion (112) represent program instructions that when executed by the processor 104 cause the computing device 100 to output a word suggestion to a display, based on the words determined from the captured voice data. The word suggestion may correspond to a word or phrase, or other information that the participant may find of relevance in order to participate in the teleconference. As an example, the output is visual, such as a graphical user interface (GUI) overlay or text prompt on a display of the computing device 100 or a display associated with the computing device 100. The visual output may be integrated into the phone or conferencing software used for the teleconference, or may remain separate.

As an example, the computing device 100 outputs the word suggestion when it is available. For example, if the captured voice data includes a sentence currently being spoken by a participant of the teleconference, the word suggestion may include a word or phrase to complete the sentence. As a result, the word suggestion includes predictions to help participants when speaking. During teleconferences, the pressure of situations can cause participants to freeze, hesitate, or lose track of what word they meant to use next. By using the captured voice data to analyze the sentence being spoken, the computing device 100 may use basic word predictions to offer suggestions real-time. The suggestions may rely on the contextual data of what was previously spoken between the participants, for example, from the captured voice data. The suggestions may then serve as a real-time reminder to help the participant complete what they were probably trying to say.

As an example, the computing device 100 may output a word suggestion by offering alternate word selections when the participant is using a particular word too often. While the computing device 100 analyzes captured voice data to determine words in the voice data, the computing device 100 may tally each word spoken by a participant of the teleconference, in order to determine whether any word spoken by the participant exceeds an adjustable limit. Alternate word selections may include synonyms of the overused word. As an example, rather than providing an alternate word selection, an alert may be output to the display, informing the participant of the overuse of the word.

As an example, the computing device 100 may output a word suggestion when words in the captured voice data include keywords regarding current events. This may be particularly useful when a participant may not know enough information concerning the current event that is currently being discussed on the teleconference. As an example, the computing device 100 may have a database of current events, or other hot topics that are of relevance. Upon determining that a word spoken in the captured voice data matches a current event or hot topic, the computing device 100 may output information regarding the current event. Upon reviewing the information output by the computing device 100, the participant may be able to effectively participate in the conversation.

Memory device 106 represents generally any number of memory components capable of storing instructions that can be executed by processor 104. Memory device 106 is non-transitory in the sense that it does not encompass a transitory signal but instead is made up of at least one memory component configured to store the relevant instructions. As a result, the memory device 106 may be a non-transitory computer-readable storage medium. Memory device 106 may be implemented in a single device or distributed across devices. Likewise, processor 104 represents any number of processors capable of executing instructions stored by memory device 106. Processor 104 may be integrated in a single device or distributed across devices. Further, memory device 106 may be fully or partially integrated in the same device as processor 104, or it may be separate but accessible to that device and processor 104.

In one example, the program instructions 108-112 can be part of an installation package that when installed can be executed by processor 104 to implement the components of the computing device 100. In this case, memory device 106 may be a portable medium such as a CD, DVD, or flash drive or a memory maintained by a server from which the installation package can be downloaded and installed. In another example, the program instructions may be part of an application or applications already installed. Here, memory device 106 can include integrated memory such as a hard drive, solid state drive, or the like.

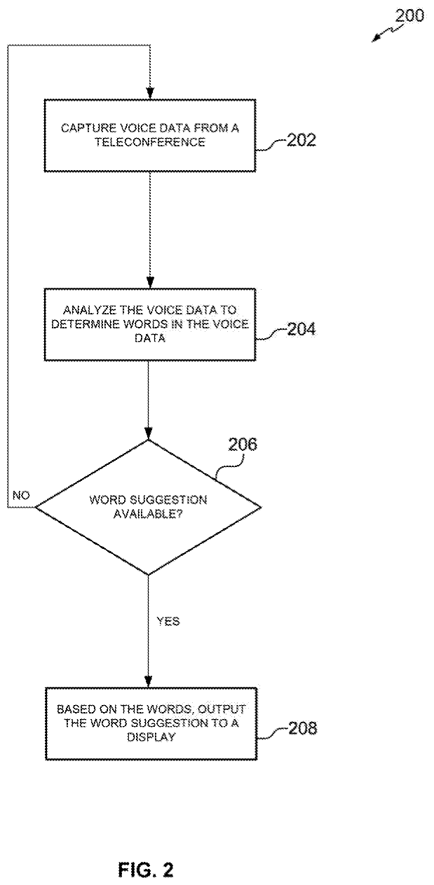

FIG. 2 illustrates a method 200 at a computing device for outputting suggestions in real-time, based on captured voice data, according to an example. In discussing FIG. 2, reference may be made to the example computing device 100 illustrated in FIG. 1. Such reference is made to provide contextual examples and not to limit the manner in which method 200 depicted by FIG. 2 may be implemented.

Method 200 begins at 202, where the computing device captures voice data from a teleconference that the computing device is logged into. The captured voice data may correspond to participants speaking into a microphone of the computing device and other participants logged into the teleconference from remote locations, for example, from their own computing devices. At 204, the computing device analyzes the captured voice data to determine words in the voice data. As described above, SR systems may be used to determine the words in the voice data.

At 206, the computing device determines whether a word suggestion is available, based on the voice data captured thus far. The suggestions may rely on the contextual data of what was previously spoken between the participants, for example, from the captured voice data. At 208, if a word suggestion is available, the computing device outputs the word suggestion to a display, based on the words determined from the captured voice data. As an example, if the captured voice data includes a sentence currently being spoken by a participant of the teleconference, the word suggestion may include a word or phrase to complete the sentence. As a result, the word suggestion includes predictions to help participants when speaking. The suggestions may serve as a real-time reminder to help the participant complete what they were probably trying to say.

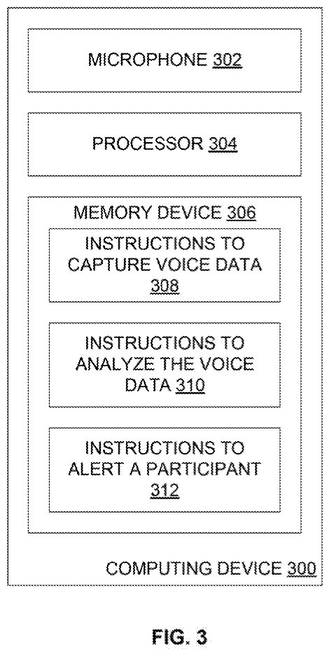

FIG. 3 illustrates a computing device 300 for alerting a participant in real-time, based on captured voice data, according to an example. The computing device 300 may correspond to a portable computing device, such as a smartphone or a notebook computer, with a microphone 302 associated with the computing device 300. As an example, the microphone 302 may be internal to the computing device 300 or external to the computing device 300, such as a Bluetooth headset. As described above, a participant may log into a teleconference using the computing device 300, and participate in the teleconference by speaking into microphone 302. As will be further described, the computing device 100 may continually analyze conversations between participants during the teleconference to provide real-time alerts to the participant, for example, when words spoken during the teleconference are associated with the participant.

The computing device 300 depicts a processor 304 and a memory device 306 and, as an example of the computing device 300 performing its operations, the memory device 306 may include instructions 308-312 that are executable by the processor 304. Thus, memory device 306 can be said to store program instructions that, when executed by processor 304, implement the components of the computing device 300. The executable program instructions stored in the memory device 306 include, as an example, instructions to capture voice data (308), instructions to analyze the voice data (310), and instructions to alert a participant (312).

Instructions to capture voice data (308) represent program instructions that when executed by the processor 304 cause the computing device 300 to capture voice data from a teleconference that the computing device 300 is logged into. The captured voice data may correspond to participants speaking into the microphone 302 of the computing device 300 and other participants logged into the teleconference from remote locations, for example, from their own computing devices. As an example, voice recognition techniques may be used to differentiate one participant from another.

Instructions to analyze the voice data (310) represent program instructions that when executed by the processor 304 cause the computing device 300 to analyze the captured voice data to determine words in the voice data. As an example, SR systems may be used to determine the words in the voice data, as described above.

Instructions to alert a participant (312) represent program instructions that when executed by the processor 304 cause the computing device 300 to alert a participant of the teleconference when the words from the captured voice data include a word that is associated with the participant. As an example, the alert may be output to a display. The output may be visual, such as a GUI overlay or text prompt on a display of the computing device 300 or a display associated with the computing device 300, as described above.

As an example, the computing device 300 outputs the alerts when it is available. For example, while analyzing the captured voice data, examples of words that may be associated with the participant includes, but are not limited to, a name or title of the participant, a role of the participant, and topics of interest that are relevant to the participant. By measuring the context of what is being spoken during the teleconference, the participant may be alerted when a word is spoken that is associated with the participant. By capturing the participant's attention, the teleconference may proceed efficiently, as it is not likely that what is being spoken will have to be repeated for the participant.

In addition to capturing the participant's attention when a word associated with the participant is spoken, the participant may also receive a relevant alert when a word associated with another participant of the teleconference is spoken. For example, while the computing device 300 analyzes words from the captured voice data, the participant may receive an alert when the words include a word that is associated with another participant of the teleconference. This alert may include, as an example, information concerning the other participant that may prove beneficial during the teleconference, such as the name and role of the other participant, available social network data, and metrics of past interaction with the other participant.

As an example, the computing device 300 may output an alert when the name of a file stored on the computing device 300 is mentioned during the teleconference. The alert may include a link to the file, or a preview of the file stored on the computing device 300. As a result, when relevant files are mentioned during the teleconference, that may be stored on the computing device 300, the alert may provide useful information for the participants to continue having a productive conversation. As another example, if at the end of the teleconference the participants are checking each other's availability to schedule a follow up meeting, if such scheduling information is mentioned during the teleconference, the participant may receive an alert with the participant's availability with regards to times proposed by other participants. As a result, the participant may be able to confirm availability without even having to open their calendar.

Memory device 306 represents generally any number of memory components capable of storing instructions that can be executed by processor 304. Memory device 306 is non-transitory in the sense that it does not encompass a transitory signal but instead is made up of at least one memory component configured to store the relevant instructions. As a result, the memory device 306 may be a non-transitory computer-readable storage medium. Memory device 306 may be implemented in a single device or distributed across devices. Likewise, processor 304 represents any number of processors capable of executing instructions stored by memory device 306. Processor 304 may be integrated in a single device or distributed across devices. Further, memory device 306 may be fully or partially integrated in the same device as processor 304, or it may be separate but accessible to that device and processor 304.

In one example, the program instructions 308-312 can be part of an installation package that when installed can be executed by processor 304 to implement the components of the computing device 300. In this case, memory device 306 may be a portable medium such as a CD, DVD, or flash drive or a memory maintained by a server from which the installation package can be downloaded and installed. In another example, the program instructions may be part of an application or applications already installed. Here, memory device 306 can include integrated memory such as a hard drive, solid state drive, or the like.

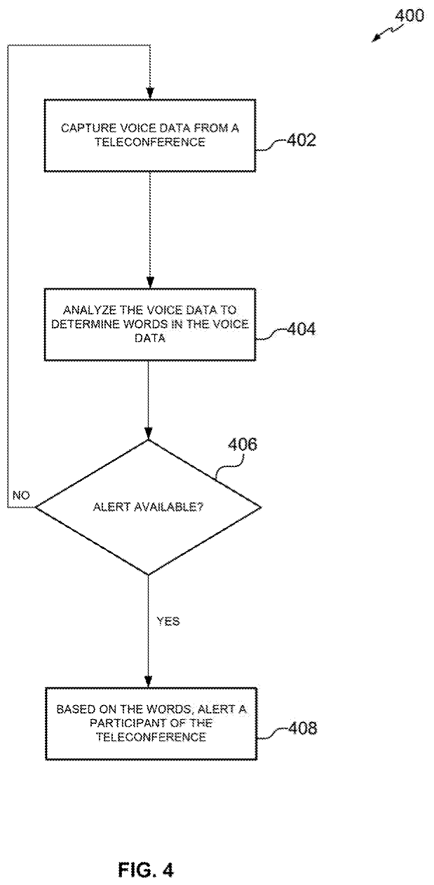

FIG. 4 illustrates a method 400 at a computing device for alerting a participant in real-time, based on captured voice data, according to an example. In discussing FIG. 4, reference may be made to the example computing device 300 illustrated in FIG. 3. Such reference is made to provide contextual examples and not to limit the manner in which method 400 depicted by FIG. 4 may be implemented.

Method 400 begins at 402, where the computing device captures voice data from a teleconference that the computing device is logged into. The captured voice data may correspond to participants speaking into a microphone of the computing device and other participants logged into the teleconference from remote locations, for example, from their own computing devices. At 404, the computing device analyzes the captured voice data to determine words in the voice data. As described above, SR systems may be used to determine the words in the voice data.

At 406, the computing device determines whether an alert is available, based on the voice data captured thus far. As an example, an alert may be available if words from the captured voice data include a word that is associated with the participant, or even another participant. At 408, if an alert is available, the computing device alerts the participant. The alert may be output to a display. As an example, while analyzing the captured voice data, examples of words that may be associated with the participant Includes, but are not limited to, a name or title of the participant, a role of the participant, and topics of interest that are relevant to the participant. By measuring the context of what is being spoken during the teleconference, the participant may be alerted when a word is spoken that is associated with the participant. As mentioned above, the participant may also receive a relevant alert when a word associated with another participant of the teleconference is spoken.

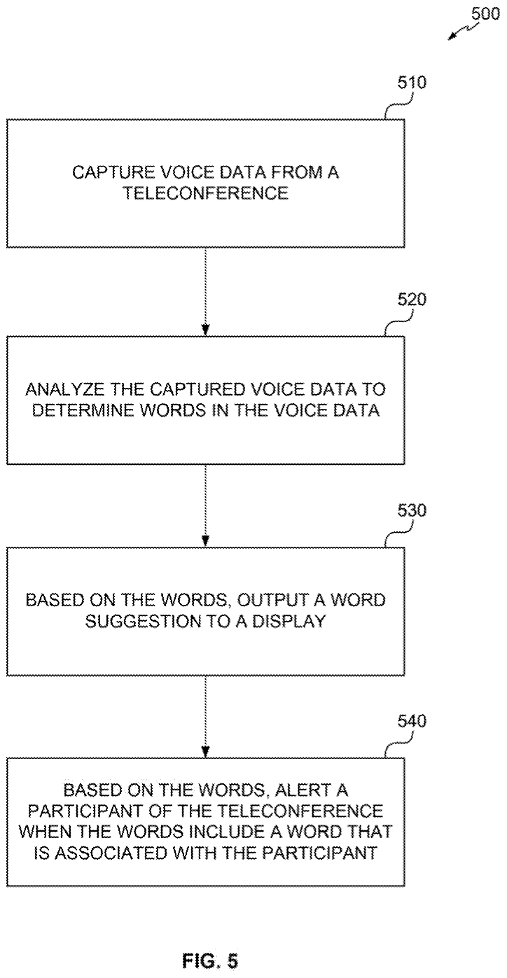

FIG. 5 is a flow diagram 500 of steps taken by a computing device to implement a method for providing relevant information to a participant of a teleconference, according to an example. Although the flow diagram of FIG. 5 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

At 510, the computing device captures voice data from a teleconference that the computing device is logged into. The captured voice data may correspond to participants speaking into a microphone of the computing device and other participants logged into the teleconference from remote locations, for example, from their own computing devices. As an example, voice recognition techniques may be used to differentiate one participant from another.

At 520, the computing device analyzes the captured voice data to determine words in the voice data. As an example, SR systems may be used to determine the words in the voice data, such as the speaker independent SR systems and speaker dependent SR systems described above.

At 530, the computing device, based on the words from the captured voice data, outputs an available word suggestion to a display. The word suggestion may correspond to a word or phrase, or other information that the participant may find of relevance in order to participate in the teleconference. As an example, the output is visual, such as a GUI overlay or text prompt on a display of the computing device or a display associated with the computing device, as described above. As an example of when a word suggestion may be available, if the captured voice data includes a sentence currently being spoken by a participant of the teleconference, the word suggestion may include a word or phrase to complete the sentence. By continually analyzing what is spoken between the participants on the teleconference, the computing device may continue to output relevant word suggestions.

At 540, the computing device, based on the words from the captured voice data, may also alert a participant of the teleconference when the words include a word that is associated with the participant. As an example, the alert may be output to a display, such as a GUI overlay or text prompt on a display of the computing device. As an example, while analyzing the captured voice data, examples of words that may be associated with the participant includes, but are not limited to, a name or title of the participant, a role of the participant, and topics of interest that are relevant to the participant. By measuring the context of what is being spoken during the teleconference, the participant may be alerted when a word is spoken that is associated with the participant. In addition to capturing the participant's attention when a word associated with the participant is spoken, the participant may also receive a relevant alert when a word associated with another participant of the teleconference is spoken.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A computing device comprising a processor to:
capture voice data from a teleconference that the computing device is logged into;
analyze the captured voice data to determine words in the voice data; and
based on the words, output a word suggestion to a display.

2. The computing device of claim 1, wherein the captured voice data comprises a sentence currently being spoken by a participant of the teleconference, and the word suggestion comprises a word or phrase to complete the sentence.

3. The computing device of claim 1, wherein the processor to analyze the captured voice data comprises tallying each word spoken by a participant of the teleconference.

4. The computing device of claim 3, wherein the word suggestion comprises an alternate word selection to a word spoken by the participant over a limit.

5. The computing device of claim 1, wherein the words in the voice data comprise keywords regarding current events, and the word suggestion comprises information regarding the current events.

6. A non-transitory computer-readable storage medium comprising program instructions which, when executed by a processor, to cause the processor of a computing device to:
capture voice data from a teleconference that the computing device is logged into;
analyze the captured voice data to determine words in the voice data; and
based on the words, alert a participant of the teleconference when the words include a word that is associated with the participant.

7. The non-transitory computer-readable storage medium of claim 6, wherein the word that is associated with the participant comprises a name of the participant, a role of the participant, topics of interest that are relevant to the participant, a name of a file stored on the computing device, and scheduling information.

8. The non-transitory computer-readable storage medium of claim 7, wherein the program instructions to cause the processor to alert the participant comprises program instructions to output the alert to a display.

9. The non-transitory computer-readable storage medium of claim 7, wherein the alert comprises a link or preview to the file stored on the computing device.

10. The non-transitory computer-readable storage medium of claim 7, wherein the alert comprises availability of the participant with regards to the scheduling information.

11. The non-transitory computer-readable storage medium of claim 6, comprising program instructions to cause the processor to alert the participant when the words include a word that is associated with another participant of the teleconference.

12. A method comprising:
capturing, via a computing device, voice data from a teleconference;
analyzing the captured voice data to determine words in the voice data; and
based on the words:
outputting a word suggestion to a display associated with the computing device, and
alerting a participant of the teleconference when the words include a word that is associated with the participant.

13. The method of claim 12, wherein the captured voice data comprises a sentence currently being spoken by a participant of the teleconference, and outputting the word suggestion comprises outputting a word or phrase to complete the sentence.

14. The method of claim 12, wherein the word that is associated with the participant comprises a name of the participant, a role of the participant, topics of interest that are relevant to the participant, a name of a file stored on the computing device, and scheduling information.

15. The method of claim 12, comprising alerting the participant when the words include a word that is associated with another participant of the teleconference.
